(19) United States
(12) Patent Application Publication
(10) Pub. No.: US 2017/0322091 A1
(43) Pub. Date: Nov. 9, 2017

(54) OPEN AIR THERMOWELL

(71) Applicant: Gas Turbine Specialty Parts LLC, Avondale, AZ (US)

(72) Inventor: Victor Sanchez, Brea, CA (US)

(21) Appl. No.: 15/146,027

(22) Filed: May 4, 2016

(51) Int. Cl. G01K 1/08; G01K 7/04; G01K 7/02

(52) U.S. Cl. CPC G01K 1/08; G01K 7/023; G01K 7/04

(57) ABSTRACT

An open air thermowell system includes a measurement protection device, a temperature measurement device, a torque mechanism, and a torque transfer mechanism.

### TECHNICAL FIELD

The present invention is generally related to measuring temperature in industrial processes. More particularly, the present invention increases thermocouple stability within a thermowell application.

### BACKGROUND

Thermowells are used to measure temperature in industrial processes. Rather than directly placing a temperature sensor into a process stream, a thermowell is used to enable the temperature-sensing device to be protected as well as removed and replaced without disturbing the process. Thermowells are tube-like devices that are lowered into the process stream of material (e.g., liquid or gas), which are closed at the end placed into the process stream and open at the other end. A temperature sensor is placed inside the open end to take temperature measurements.

A thermocouple is one type of temperature sensor that is placed inside a thermowell. Thermocouples are well known and widely used in many industries. A thermocouple is a device that will produce electricity when subjected to temperature. When a thermowell-thermocouple device is place within a process stream of material, the thermowell becomes heated. The heat from the thermowell walls is transferred to the thermocouple device. The electricity from the thermocouple device may be used to operate temperature sensing and control devices. Another type of sensor, a resistance temperature detector (RTD), may also be used in conjunction with a thermowell. An RTD employs a wound wire or thin film to measure temperature. As temperature increases, the electrical resistance of the RTD material will increase.

Typically, a thermowell is mounted in a process stream. Then a thermocouple or RTD is inserted in the open end of a thermowell. It is important that the thermowell and the thermocouple do not touch or otherwise interact with each other else inaccurate readings or damage to the devices will occur. For example, the end of the thermocouple begins to vibrate due to process flow and extreme temperatures. Such vibration can have devastating effects on the thermocouple and thermowell damaging both beyond repair. In some applications, the thermocouple is secured in the thermowell by one or more springs. However, in many applications, the springs are unable to maintain the pressure needed to keep the thermocouple's position stable. As a result, failures and the time and costs to repair such failures increase. What is needed is a system that increases thermocouple stability.

### SUMMARY

While the way in which the present invention addresses the disadvantages of the prior art will be discussed in greater detail below, in general, the present invention provides for increasing thermocouple stability within a thermowell. In particular, a multi-piece thermowell system includes a measurement protection device, a temperature measurement device, a torque mechanism, and a torque transfer mechanism.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description, or may be learned by the practice of the invention.

### BRIEF DESCRIPTION OF THE DRAWINGS

In order to describe the manner in which the advantages and features of the present invention can be obtained, a more particular description of the present invention will be rendered by reference to specific embodiments and examples, which are illustrated in the appended drawings. Understanding that these drawings depict only typical embodiments of the invention and are not therefore to be considered to be limiting of its scope, the present invention will be described and explained with additional specificity and detail through the use of the accompanying drawings in which:

FIG. 1 illustrates a side view of an exemplary open air thermowell system of the present invention.

FIG. 1A illustrates an exploded view of an exemplary open air thermowell system of the present invention.

FIG. 2 illustrates an expanded view of a disk assembly area of an exemplary open air thermowell system of the present invention.

FIG. 2A illustrates an expanded view of a disk assembly of an exemplary open air thermowell system of the present invention.

FIG. 3 illustrates an expanded view of a cavity at the top of an exemplary open air thermowell system of the present invention.

### DETAILED DESCRIPTION

Various embodiments of the invention are described in detail below. A person skilled in the relevant art will recognize that other components and configurations may be easily used or substituted than those that are described here without parting from the spirit and scope of the invention. As will be appreciated by one of ordinary skill in the art, the system may be embodied as a customization of an existing system, an add-on product, and/or a stand-alone system.

As will become apparent from the following descriptions, the present invention increases thermocouple stability within a thermowell. A multi-piece thermowell system includes any hardware and/or software suitably configured to stabilize a temperature measurement device within a thermowell. In general, the multi-piece thermowell system includes a measurement protection device, a temperature measurement device, a torque mechanism, and a torque transfer mechanism. The system may be constructed from or fabricated from a variety of materials suitable for a particular application of the thermowell system. In a preferred embodiment, the material is stainless steel or similar material. The system may be constructed in a number of pieces depending on the application. In some embodiments, the thermowell system is constructed in three pieces. In other embodiments, the thermowell system is constructed in two pieces. However, any number of pieces used to construct system is within the spirit and scope of this invention. The multi-piece thermowell system may be used in any application that needs to measure temperatures of a process stream. In exemplary embodiments, the system is used in gas turbine applications.

The multi-piece thermowell system includes any hardware suitably configured to protect a temperature measurement device installed in a process stream. In some embodiments, this measurement protection device is known as a thermowell. A thermowell is usually a tubular like fitting closed at one end and installed in a process stream. The types and uses of thermowells are well known in the art and will not be explained in detail. However, any device known to protect temperature measurement devices installed in process streams is within the spirit and scope of the present invention.

The multi-piece thermowell system includes any hardware and/or software configured to measure temperature of a process stream when operably attached to a temperature measurement protection device. In some embodiments, the temperature measurement device is a thermometer. In other embodiments, the measurement device is a resistance detector. In yet other embodiments, the measurement device is a thermocouple.

The multi-piece thermowell system includes any hardware suitably configured as a torque mechanism to torque the temperature measurement device internally at the seat to prevent movement within the protection device. Typically, the measurement device is placed within the protection device and seated to the protection device through washers, springs, direct contact or other similar mounting structures. In an exemplary embodiment, the torqueing mechanism is a torque tube. In some embodiments, the torqueing mechanism is assembled as part of the protection device. In other embodiments, the torqueing mechanism is assembled as part of the temperature measurement device.

The multi-piece thermowell system includes any hardware suitably configured as a torque transfer mechanism. The torque transfer mechanism allows a user to transfer the desired torqueing of the temperature measurement device to the seat of the protection device. The torque transfer mechanism may be assembled as part of the temperature measurement device, the protection device, or as a stand-alone component. In an exemplary embodiment, the torque transfer mechanism is a torque nut.

Once assembled the temperature measurement device is allowed to stabilize or “float” within the protection device. The assembly enables the temperature measurement device to freely expand and contract within the thermowell. At the same time, the assembly prevents the temperature measurement device from becoming destabilized due to vibration of the temperature measure device or the thermowell.

While specific implementations involving a multi-piece thermowell system are described below, it should be understood that their description is merely illustrative and not intended to limit the scope of the various aspects of the invention.

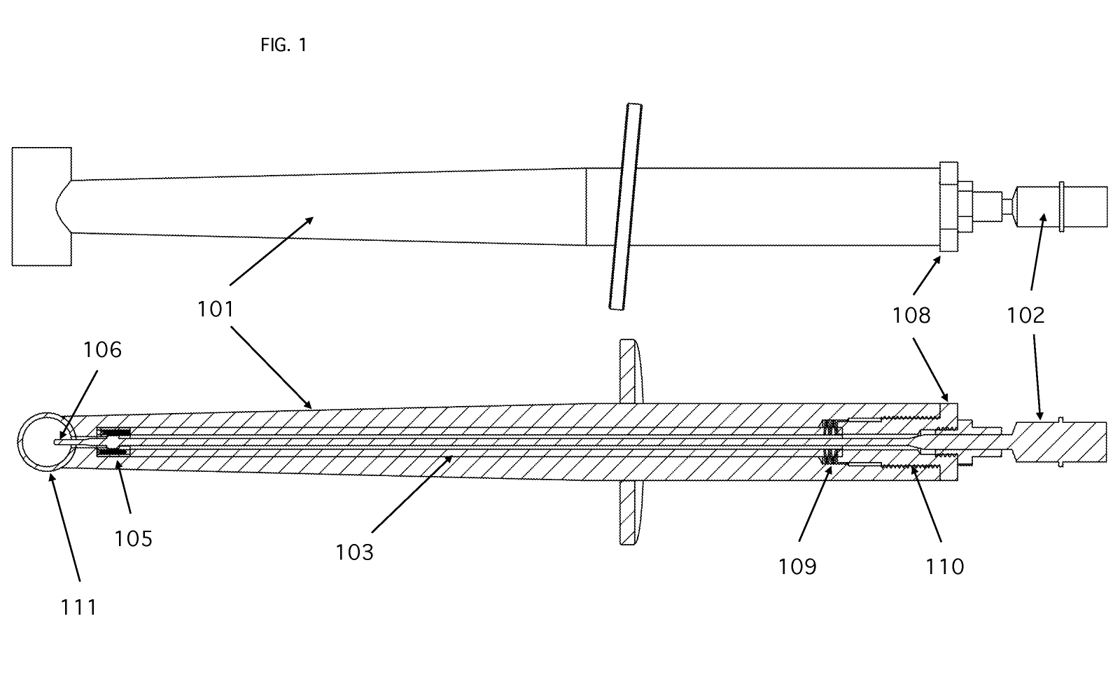

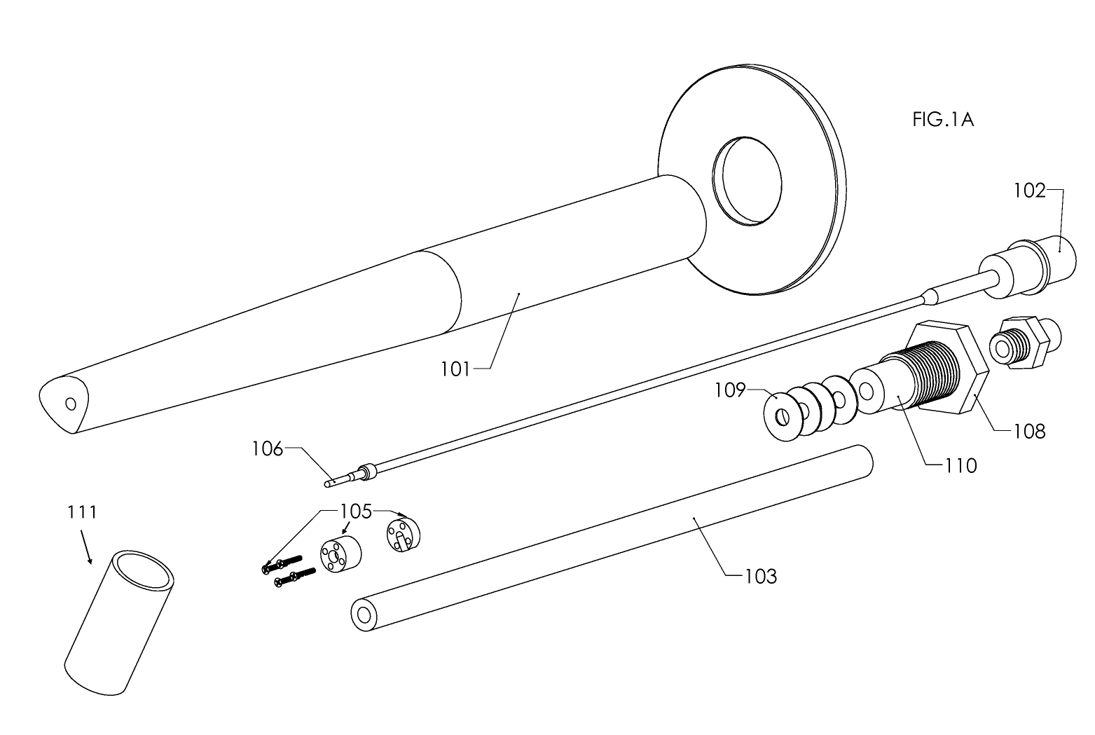

FIGS. 1 and 1A illustrate a side view and an exploded view of an exemplary open air thermowell system of the present invention. One application of this system is for gas turbine exhaust monitoring. A thermocouple 102 is situated within an internal cavity of a thermowell 101. The thermocouple 102 is inserted through a torque nut 108 and a disk assembly 105. The disk assembly 105 is seated at the bottom of the cavity of the thermowell 101. The thermocouple 102 is installed deep enough into the thermowell 101 so that the monitoring point 106 is able to appropriately measure the temperature of the process stream upon installation. A shield 111 is coupled to the bottom of the thermowell 101 to protect the monitoring point 106 from damage. The shield 111 and the monitoring point 106 are inserted in the process stream. Optionally, the other end of the thermocouple (i.e., the open air end) may have electrical connecters attached to use for monitoring and control purposes.

A torque tube 103 is situated within the cavity of the thermowell 101. The thermocouple 102 is situated within the torque tube 103. The bottom of the torque tube 103 applies pressure to the disk assembly 105 to add stability and prevent movement during operation. The disk assembly 105 is recessed into the thermowell 101 and exposed to the torque tube 103. The disk assembly 105 may be attached to the thermocouple 102 using a variety of attachment methods or systems. In some embodiments, the disk assembly 105 is attached by welding the disk assembly 105 to the thermocouple 102. In other embodiments, the thermocouple 102 is removable from the disk assembly 105.

The thermocouple 102 is secured at the top of the thermowell 101 by a torque nut 108 and washers 109. The washers 109 sit inside a cavity at the top of the thermowell 101. In exemplary embodiments, the washers 109 are Belleville washers. Threading 110 is provided for the torque nut 108. Once the thermowell system is assembled, the torque nut 108 is twisted so that the torque nut 108 travels through the cavity at the top of the thermowell and applies downward pressure on the torque tube 103. In an exemplary embodiment, the torque net 108 is fitted for a torque wrench.

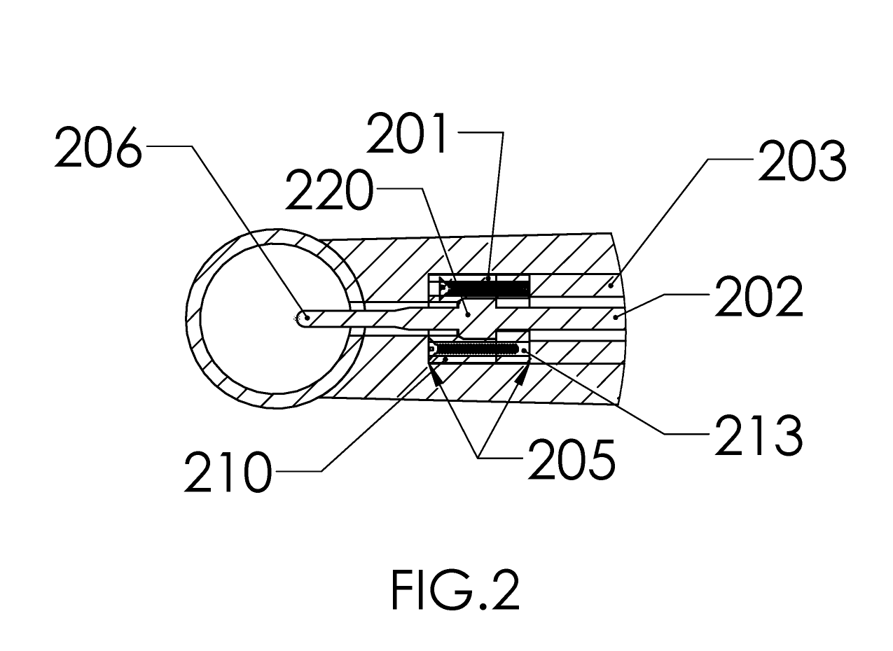

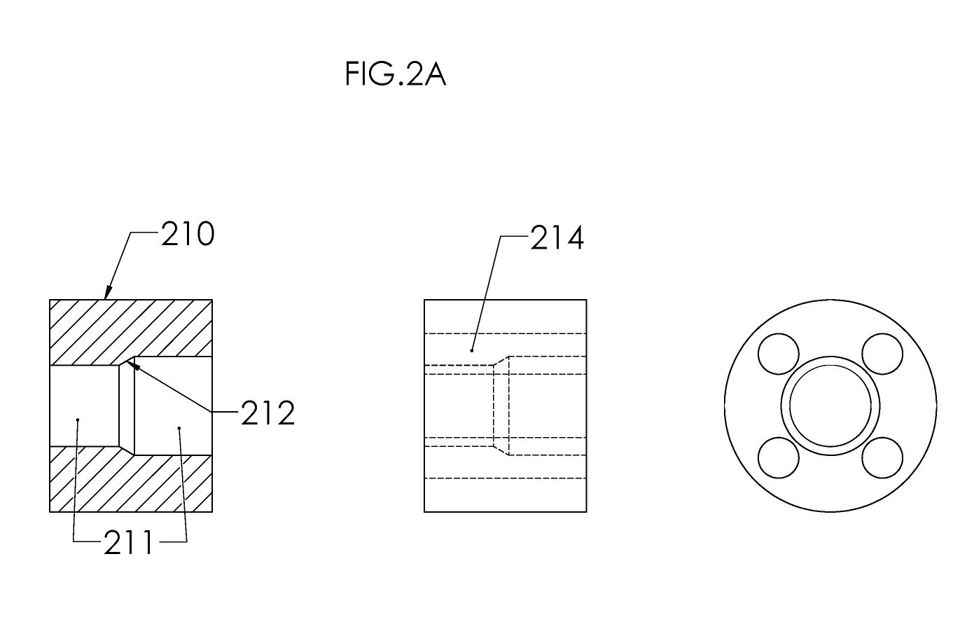

FIG. 2 illustrates an expanded view of the disk assembly area of an exemplary open air thermowell system of the present invention. The inner cavity of the thermowell 201 is configured to receive the disk assembly 205 when inserted. The thermocouple 202 is inserted through the disk assembly 205 so that the monitoring point 206 is able to appropriately measure the temperature of the process stream. The torque tube 203 engages the top of the disk assembly 205 such that torque applied to the torque tube will apply downward pressure on the disk assembly 205. The downward pressure increases stability and prevents movement of the disk assembly 205 and the thermocouple 202.

FIG. 2A illustrates an expanded view of a disk assembly of an exemplary open air thermowell system of the present invention. A disk assembly contains a lower tube 210 (also depicted in FIG. 2) having an inner cavity with two openings at the top and bottom 211. The inner cavity 211 is configured with one or more steps 212 such that when a thermocouple is inserted into the cavity, it becomes seated against the step(s) 212. The thermocouple is configured with a collar 220 (depicted in FIG. 2) that becomes seated appropriately within the one or more steps. In these embodiments, a second tube 213 or washer is installed above the collar securing the thermocouple within the disk assembly. Tubes 210 and 213 contain one more attachment cavities 214 for securing the tubes together, for example, with screws. Depending on the application, the disk assembly may be secured to the thermowell or may be removable.

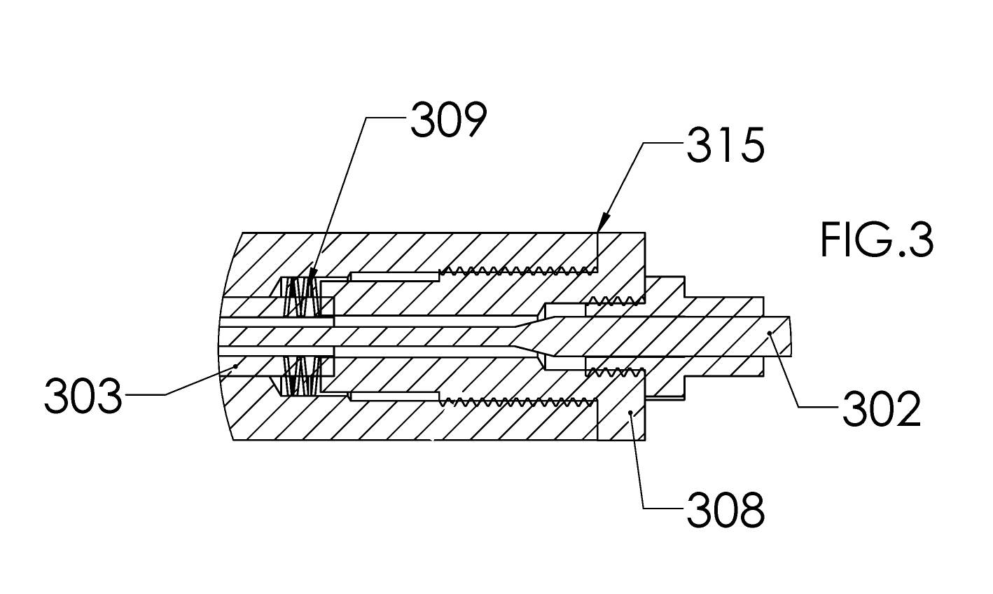

FIG. 3 illustrates an expanded view of a cavity at the top of an exemplary open air thermowell system of the present invention. As indicated in FIG. 1, a cavity 315 at the top of the thermowell receives one or more washers 309. In exemplary embodiments, the washers 309 are Belleville washers. The thermocouple 302 is placed through the washers 309, extended into the torque tube 303 and installed appropriately at the disk assembly area at the bottom of the thermowell (as described in FIGS. 1 and 2). The torque nut 308 is screwed into the top of the cavity 315. Once assembled, the downward pressure applied by the torque nut 308 prevents the bottom of the thermocouple 302 from becoming destabilized. The washers 309 held in place by the torque nut 308 are allowed to expand and contract due to the heating and vibration of the thermowell without destabilizing the thermocouple 302.

Although the above description may contain specific details, they should not be construed as limiting the claims in any way. Other configurations and equivalents of the described embodiments of the invention are part of the scope of this invention. The descriptions and embodiments are not intended to be an exhaustive or to limit the invention to the precise forms disclosed.

I claim:

1. An apparatus comprising:
a measurement protection device having an internal cavity, the internal cavity having a first end and a first end aperture that extends from the internal cavity to the first end;
a temperature measurement device having a measurement end, the temperature measurement device situated within the internal cavity so that the measurement end extends beyond the measurement protection device through the first end aperture;
a torque mechanism situated within the internal cavity operably attached to the temperature measurement device and the measurement protection device, the torque mechanism seated to the measurement protection device so as to prevent movement of the temperature measurement device within the internal cavity;
a torque transfer mechanism operably attached to the torque mechanism configured to transfer force to the temperature measure device.

2. The apparatus of claim 1, wherein the measurement protection device and the torque mechanism are manufactured as a single piece.

3. The apparatus of claim 1, wherein the torque transfer mechanism and the torque mechanism are manufactured as a single piece.

4. The apparatus of claim 1, wherein the measurement protection device is stainless steel.

5. The apparatus of claim 1, wherein the temperature measurement device includes a seating disk.

6. An open air thermowell apparatus comprising:
a thermowell having an internal cavity with a first end and a second end, the ends open to areas outside the thermowell;
a disk assembly situated within the internal cavity configured to seal the internal cavity near the second end, the seating disk having an aperture;
a hollow torque tube situated within the internal cavity having a third end and a fourth end, the fourth end coupled to seating disk;
a thermocouple having a measurement end and a top end situated within the torque tube, the measurement end extending through the disk assembly aperture and beyond the second end;
a torque nut coupled to a washer, the washer coupled to the third end of the torque tube, the torque nut operably attached to the first end of the thermowell and the torque nut having aperture throughout the length of the torque nut wherein the top end of the thermocouple extends through the torque net aperture.

7. The apparatus of claim 6, wherein the washer is a Belleville washer.

8. The apparatus of claim 6, further comprising a swage fitting operably attached to the torque net, the swage fitting having an aperture throughout the length of the swage fitting; the thermocouple having a top end, the top end extending through the swage fitting aperture.

9. The apparatus of claim 6, wherein the thermowell and the disk assembly are manufactured as one piece.

10. The apparatus of claim 6, wherein the torque tube and the torque nut are manufactured as one piece.

11. The apparatus of claim 6, wherein the torque tube and the thermowell are manufactured as one piece.

12. The apparatus of claim 6, wherein the thermowell is stainless steel.

13. The apparatus of claim 6, further comprising an electrical connection operably attached to the top end of the thermocouple.
